(19) United States
(12) Patent Application Publication
(10) Pub. No.: US 2026/0352451 A1
(43) Pub. Date: Nov. 5, 2026

(54) QUANTUM-RESISTANT ATTESTED KEY AND MODEL LIFECYCLE MANAGEMENT SYSTEM

(71) Applicant: George William Bickerstaff, III, Greenwich, CT (US)

(72) Inventor: George William Bickerstaff, III, Greenwich, CT (US)

(21) Appl. No.: 19/714,456

(22) Filed: Jun. 20, 2026

Related U.S. Application Data
(60) Provisional application No. 64/054,318, filed on Apr. 30, 2026.

(51) Int. Cl. H04L 9/08; G06F 21/53

(52) U.S. Cl. CPC H04L 9/0852; G06F 21/53

(57) ABSTRACT

A quantum-resistant system manages the key and model lifecycle of an artificial intelligence model within a trusted execution environment (TEE). A key management engine generates, seals, rotates, and revokes post-quantum keys bound to a hardware-rooted measurement. A secure model update module applies attested changes linking a prior state to a new state. A verifiable fine-tuning module binds, as a single signed unit, digests of training data, gradients, and resulting weights to the measurement. A tamper-evident provenance ledger records the operations and may anchor digests to a public blockchain. The system may mint a self-sovereign agent identity for consumption by a separate orchestration subsystem. Keys, updates, and evidence exist unencrypted only within the TEE and are tamper-evidently bound to the measurement, so an operator cannot alter or suppress them without invalidating the attestation.

### CROSS-REFERENCE TO RELATED APPLICATIONS

This application claims the benefit of U.S. Provisional Patent Application No. 64/054,318, filed Apr. 30, 2026, under USPTO Customer Number 212041, the entire disclosure of which is incorporated herein by reference.

### FIELD OF THE INVENTION

The present disclosure relates to quantum-resistant dynamic key management, secure model updating, verifiable fine-tuning, and attested lifecycle management of artificial intelligence agents and models operating within hardware-rooted trusted execution environments. A key rotation performed by the dynamic key management engine preserves the continuous attestation chain, such that a rotation or revocation event does not interrupt the attested lifecycle or the binding of model state to the hardware-rooted measurement relied upon by a separate runtime-attestation subsystem.

### BACKGROUND OF THE INVENTION

Artificial intelligence models are updated, fine-tuned, and redeployed over their operational lifetimes. Existing update mechanisms lack hardware-rooted attestation of weights, prompts, and fine-tuning data, leaving them vulnerable to supply-chain attacks, model poisoning, and cryptographic threats posed by quantum computation.

A need exists for a complete post-quantum key lifecycle integrated with attested model updates and verifiable fine-tuning performed inside trusted execution environments while maintaining continuous attestation chains and tamper-evident provenance suitable for regulated and high-assurance environments.

### SUMMARY OF THE INVENTION

Disclosed are a system, a method, and a non-transitory computer-readable medium for quantum-resistant dynamic key management, secure model updating, and verifiable fine-tuning of artificial intelligence agents and models. A dynamic key management engine generates, seals, rotates, and revokes post-quantum cryptographic keys bound to hardware-rooted measurements of a trusted execution environment (TEE). A secure model update module applies attested changes to model weights, parameters, or configurations with cryptographic linkage between a prior attested state and a new state. A verifiable fine-tuning module performs fine-tuning inside the TEE while attesting training data, update gradients or deltas, and resulting weights as a bound unit. A tamper-evident provenance ledger records key operations, model updates, fine-tuning events, and agent-identity operations.

In one or more embodiments, the system mints a self-sovereign agent identity bound to a hardware-rooted measurement, the identity being consumable by a separate orchestration subsystem without that subsystem re-deriving the identity. Computations are performed over data existing in unencrypted form only within the TEE and are tamper-evidently bound to the hardware-rooted measurement. The disclosed architecture improves the functioning of a computer by providing a technical solution to a technical problem in computer security: it makes key and model-lifecycle transitions verifiable by binding key state, model state, and update provenance to a hardware-rooted measurement within a trusted execution environment, such that the integrity of a model update cannot be asserted without hardware-rooted evidence.

### BRIEF DESCRIPTION OF THE DRAWINGS

The disclosure is illustrated by way of example and not by way of limitation. The drawings are organized as five figure groups, each comprising five subfigures, designated FIG. 1A through FIG. 5E. The drawings employ descriptive labels for components and do not rely upon reference numerals; like labels indicate like components throughout.

FIG. 1 depicts the overall quantum-resistant key-lifecycle architecture and key operations, in subfigures FIG. 1A through FIG. 1E.

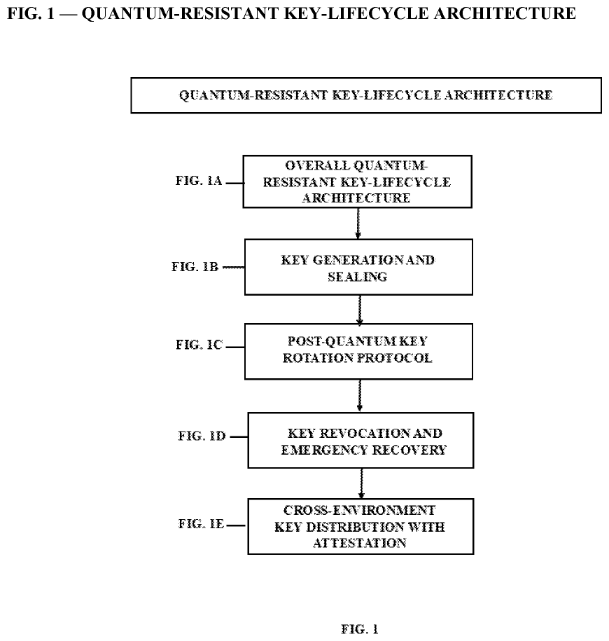

FIG. 2 depicts attested model-state update and delta binding, in subfigures FIG. 2A through FIG. 2E.

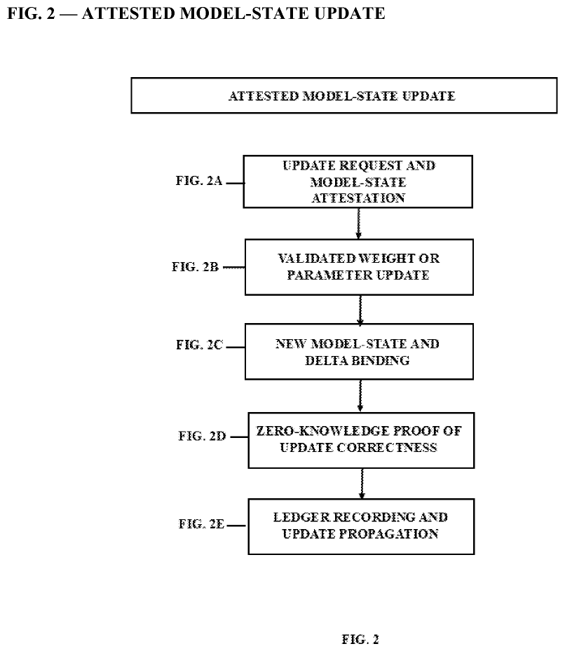

FIG. 3 depicts attested fine-tuning, weight update, and model merging, in subfigures FIG. 3A through FIG. 3E.

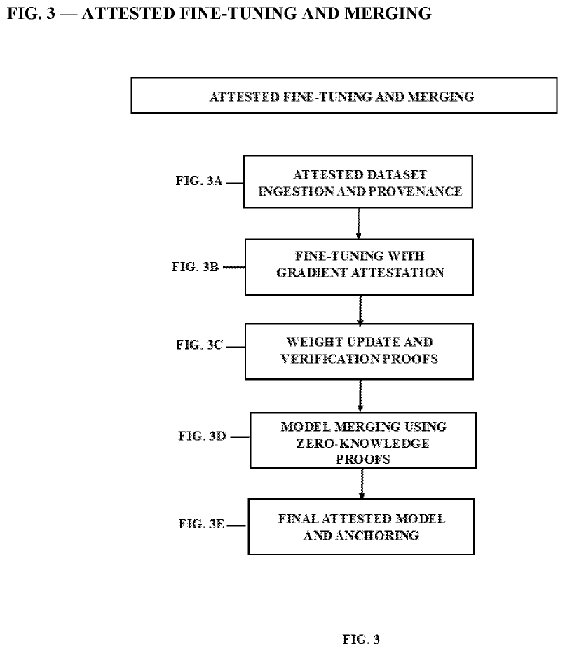

FIG. 4 depicts continuous attestation, policy-driven approval, rollback, and verification, in subfigures FIG. 4A through FIG. 4E.

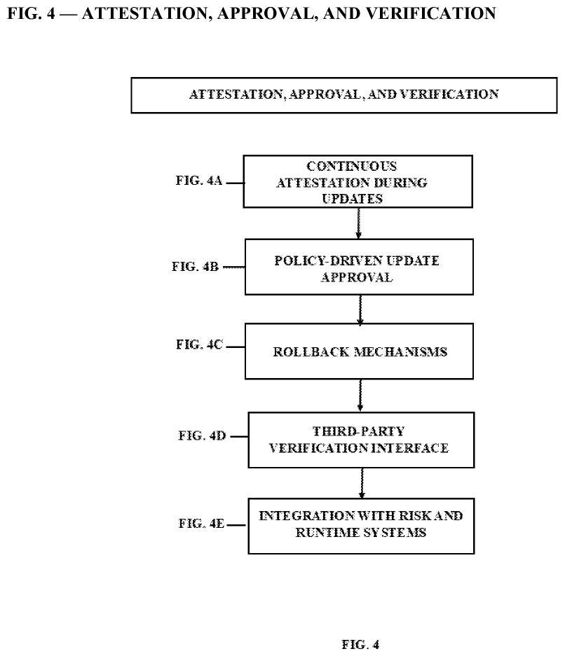

FIG. 5 depicts runtime integration, key-rotation triggers, and recovery, in subfigures FIG. 5A through FIG. 5E.

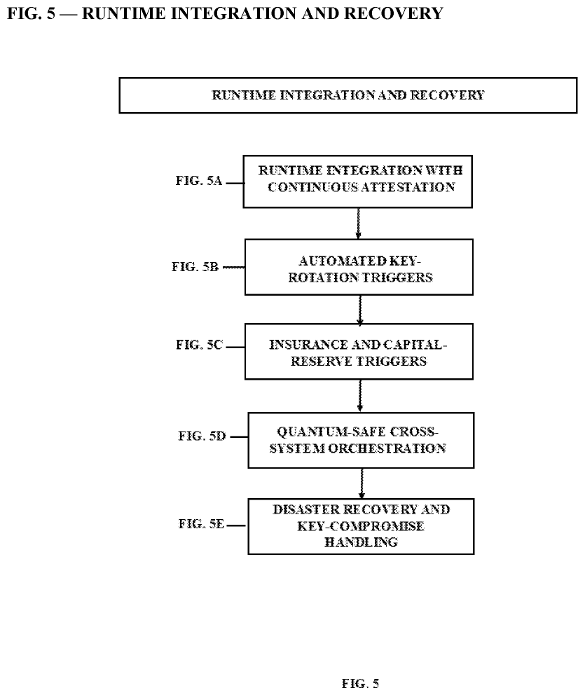

### DETAILED DESCRIPTION OF THE INVENTION

### Definitions

For purposes of the present disclosure and the appended claims, the following terms have the meanings set forth below, each definition being open in form and inclusive.

“Trusted execution environment” means a hardware-isolated execution context, instantiated on one or more processors, that protects the confidentiality and integrity of code, data, and state executing therein from observation or modification by privileged software outside the enclave, including a host operating system and a hypervisor, and that produces a hardware-rooted measurement of its software state usable for remote attestation; a TEE includes, without limitation, Intel SGX, Intel TDX, AMD SEV-SNP, ARM TrustZone, ARM CCA, AWS Nitro Enclaves, Azure Confidential Virtual Machines, Google Cloud Confidential Virtual Machines, a graphics processing unit or accelerator configured to operate in a confidential computing mode, and equivalent or successor confidential-computing primitives from any vendor.

“Dynamic key management” means the generation, rotation, revocation, escrow, and hardware-sealing of post-quantum cryptographic keys bound to TEE measurements, including but not limited to such operations.

“Secure model update” means an attested change to model weights, parameters, prompts, adapters, or configurations with cryptographic linkage between a prior attested state and a new state, including but not limited to such changes.

“Verifiable fine-tuning” means a fine-tuning process in which training data, gradients or parameter updates, and resulting weights are cryptographically attested and recorded in a tamper-evident ledger, including but not limited to such processes.

“Zero-knowledge model merging” means combining multiple attested models or updates using zero-knowledge proofs such that merged properties are verifiable without revealing individual model internals or training data, including but not limited to such combinations.

“Attested lifecycle” means the cryptographically verifiable history of key operations, model updates, fine-tuning events, and agent-identity changes recorded with hardware-rooted attestation evidence, including but not limited to such history.

“Hardware-bound key” means a cryptographic key whose use is restricted by hardware to a specific TEE state, the key being one or more of: sealed to a hardware-rooted measurement; derived from a hardware root of trust; or endorsed by a manufacturer-issued certificate.

“Post-quantum cryptography” means one or more cryptographic algorithms believed resistant to attack by quantum computation, including without limitation ML-DSA, ML-KEM, and equivalent or successor standardized algorithms.

“Self-sovereign agent identity” means a decentralized identifier cryptographically bound to a TEE measurement and to sealed private keys; in one or more embodiments the identifier is minted by a key-and-identity-lifecycle subsystem and received by a separate orchestration subsystem without re-derivation.

“Tamper-evident provenance ledger” means a cryptographically chained record, anchored periodically to a public blockchain by digest or Merkle root, configured such that alteration of a recorded entry is detectable, the specific events recorded being as recited by the claims of the application in which the term is used.

“Input” means, without limitation, a natural-language prompt, a structured specification, a policy reference, a target-runtime identifier, a formal-specification annotation, audio data, video data, sensor telemetry, a compiled binary, and a multimodal embedding.

The platform comprises a quantum-resistant key management engine executing within one or more TEEs that generates, seals, rotates, and revokes post-quantum keys bound to hardware-rooted measurements. A secure model update module applies validated changes to model weights, parameters, or configurations with cryptographic linkage between a prior attested state and a new state. A verifiable fine-tuning module performs fine-tuning inside a TEE while attesting, as a bound unit, the training data, the update gradients or deltas, and the resulting weights. A tamper-evident provenance ledger records all key operations, model updates, fine-tuning events, and agent-identity operations, and may anchor digests periodically to a public blockchain.

In one or more embodiments, the system mints a self-sovereign agent identity bound to a hardware-rooted measurement and to sealed private keys. The minted identity is exposed for consumption by a separate orchestration subsystem without that subsystem re-deriving or re-minting the identity. The system may further trigger downstream actions, including automated capital-reserve or insurance adjustments, via attested interfaces to external risk-management systems.

Two concrete embodiments are contemplated. In a first embodiment, the dynamic key management engine performs ML-KEM key encapsulation and ML-DSA signing, with keys sealed to an Intel TDX measurement, key rotation every twenty-four hours, and emergency revocation completing within a bounded interval. In a second embodiment, verifiable fine-tuning executes within an AWS Nitro Enclave, attesting a training dataset digest, per-step gradient digests, and a resulting weight digest, with zero-knowledge model merging producing a merged model whose properties are verified without revealing individual model internals. In a third embodiment, the dynamic key management engine executes within an Azure Confidential Virtual Machine, performs ML-DSA signing and ML-KEM encapsulation with keys sealed to the virtual-machine measurement, rotates keys every twelve hours, and revokes a compromised key within a bounded interval; verifiable fine-tuning attests a training-data digest, per-step gradient digests, and a resulting-weight digest as a single bound unit, and a self-sovereign agent identity is minted and exposed for a separate orchestration subsystem.

### Alternative Embodiments

The foregoing embodiments are illustrative and not limiting. Components may be combined or distributed. Alternative post-quantum algorithms, TEE platforms, and merging techniques are contemplated, including successor primitives. The system extends to prompts, agent identities, and configuration artifacts. Broader and related subject matter, including code generation and governance, formal-verification proof generation, federated multi-domain verification, runtime continuous re-attestation, and economically governed multi-agent orchestration, is reserved for one or more continuation, continuation-in-part, or divisional applications and is not claimed herein. The system recites, where applicable, attested outputs of companion subsystems as received input without re-performing the functions of those subsystems. The present disclosure consumes outputs of companion subsystems as attested inputs and does not require re-performing the companion subsystem's claimed functions.

What is claimed is:

1. A quantum-resistant system for attested key and model lifecycle management of an artificial intelligence model, the system comprising: one or more processors and one or more trusted execution environments (TEEs) instantiated thereon; a dynamic key management engine executing within at least one of the TEEs and configured to generate, seal, rotate, and revoke post-quantum cryptographic keys each bound to a hardware-rooted measurement of the TEE; a secure model update module configured to apply an attested change to weights, parameters, or a configuration of the model, the attested change comprising a cryptographic linkage between a prior attested state and a new attested state; a verifiable fine-tuning module executing within at least one of the TEEs and configured to perform a fine-tuning operation and to produce attestation evidence that binds, as a single signed unit, (i) a digest of training data, (ii) a digest of update gradients or parameter deltas, and (iii) a digest of resulting weights, each to the hardware-rooted measurement; and a tamper-evident provenance ledger configured to record the key operations, the attested change, the fine-tuning operation, and the attestation evidence; wherein the post-quantum keys, the attested change, and the attestation evidence are computed over data existing in unencrypted form only within the TEE and are tamper-evidently bound to the hardware-rooted measurement such that none of the post-quantum keys, the attested change, the resulting weights, or the attestation evidence can be altered, suppressed, or substituted by privileged software outside the TEE without invalidating the attestation evidence.

2. The system of claim 1, wherein the post-quantum cryptographic keys are generated using one or more standardized post-quantum algorithms comprising at least one of a key-encapsulation mechanism and a digital-signature algorithm.

3. The system of claim 1, wherein the verifiable fine-tuning module binds the digest of training data, the digest of update gradients or parameter deltas, and the digest of resulting weights collectively, such that verification of the attestation evidence fails if any one of the training data, the gradients or deltas, or the resulting weights is altered.

4. The system of claim 1, wherein the secure model update module is configured to reject an attested change for which the cryptographic linkage to the prior attested state cannot be verified.

5. The system of claim 1, further comprising a verification interface configured to enable a relying party independent of an operator of the system to confirm, using a public key endorsed by a hardware root of trust, that a recorded model state corresponds to attestation evidence in the provenance ledger.

6. The system of claim 1, further comprising a self-sovereign agent identity module configured to mint a decentralized identifier bound to the hardware-rooted measurement and to sealed private keys, and to expose the minted identifier for consumption by a separate orchestration subsystem without the orchestration subsystem re-deriving the identifier.

7. The system of claim 1, wherein the dynamic key management engine is configured to perform key rotation on a configured schedule and emergency key revocation within a bounded time interval.

8. The system of claim 1, further comprising a zero-knowledge model merging module configured to combine a plurality of attested models or updates using one or more zero-knowledge proofs such that a merged property is verifiable without revealing individual model internals or training data.

9. The system of claim 1, further comprising a risk interface configured to transmit a lifecycle event to at least one of an insurance underwriting system, a capital-reserve calculation system, and an enterprise risk-management system that consumes the lifecycle event to adjust a reserve or premium.

10. The system of claim 1, wherein the provenance ledger is configured to cryptographically link each entry to a prior entry and to periodically anchor a digest of entries to a public blockchain.

11. The system of claim 1, wherein the secure model update module is configured to attest a lifecycle transition of at least one of an adapter, a fine-tuning update, a prompt configuration, and a retrieval index, by binding a digest of the transition to the hardware-rooted measurement.

12. The system of claim 1, wherein the verifiable fine-tuning module is configured to perform the fine-tuning operation within the TEE such that the training data exists in unencrypted form only within the TEE.

13. The system of claim 1, wherein the secure model update module generates a model-state transition certificate that binds, in one signed structure, a hash of the prior attested state, a hash of an update request, a digest of the training data, a digest of the update gradients or parameter deltas, a digest of the resulting weights, a post-quantum key state of the dynamic key management engine, and the hardware-rooted measurement of the TEE.

14. A computer-implemented method for quantum-resistant attested key and model lifecycle management of an artificial intelligence model, the method comprising: generating, sealing, rotating, and revoking, by a dynamic key management engine executing within a trusted execution environment (TEE), post-quantum cryptographic keys each bound to a hardware-rooted measurement of the TEE; applying an attested change to weights, parameters, or a configuration of the model, the attested change comprising a cryptographic linkage between a prior attested state and a new attested state; performing a fine-tuning operation within the TEE and producing attestation evidence that binds, as a single signed unit, a digest of training data, a digest of update gradients or parameter deltas, and a digest of resulting weights, each to the hardware-rooted measurement; and recording, in a tamper-evident provenance ledger, the key operations, the attested change, the fine-tuning operation, and the attestation evidence; wherein the post-quantum keys, the attested change, and the attestation evidence are computed over data existing in unencrypted form only within the TEE and are tamper-evidently bound to the hardware-rooted measurement such that none thereof can be altered, suppressed, or substituted by privileged software outside the TEE without invalidating the attestation evidence.

15. The method of claim 14, further comprising minting a self-sovereign decentralized identifier bound to the hardware-rooted measurement and exposing the minted identifier for consumption by a separate orchestration subsystem without the orchestration subsystem re-deriving the identifier.

16. The method of claim 14, further comprising enabling a relying party independent of an operator to confirm, using a public key endorsed by a hardware root of trust, that a recorded model state corresponds to attestation evidence in the provenance ledger.

17. The method of claim 14, further comprising transmitting a lifecycle event to at least one of an insurance underwriting system, a capital-reserve calculation system, and an enterprise risk-management system that consumes the lifecycle event to adjust a reserve or premium.

18. The method of claim 14, further comprising periodically anchoring a digest of entries of the provenance ledger to a public blockchain.

19. A non-transitory computer-readable medium storing instructions that, when executed by one or more processors, cause the one or more processors to: generate, seal, rotate, and revoke, within a trusted execution environment (TEE), post-quantum cryptographic keys each bound to a hardware-rooted measurement of the TEE; apply an attested change to weights, parameters, or a configuration of an artificial intelligence model with cryptographic linkage between a prior attested state and a new attested state; perform a fine-tuning operation within the TEE and produce attestation evidence binding, as a single signed unit, a digest of training data, a digest of update gradients or parameter deltas, and a digest of resulting weights to the hardware-rooted measurement; and record, in a tamper-evident provenance ledger, the key operations, the attested change, the fine-tuning operation, and the attestation evidence; wherein the post-quantum keys, the attested change, and the attestation evidence are computed over data existing in unencrypted form only within the TEE and are tamper-evidently bound to the hardware-rooted measurement such that none thereof can be altered, suppressed, or substituted by privileged software outside the TEE without invalidating the attestation evidence.

20. The non-transitory computer-readable medium of claim 19, wherein the instructions further cause the one or more processors to mint a self-sovereign decentralized identifier bound to the hardware-rooted measurement and to expose the minted identifier for consumption by a separate orchestration subsystem without the orchestration subsystem re-deriving the identifier.
